(19) United States
(12) Patent Application Publication
(10) Pub. No.: US 2014/0260612 A1
(43) Pub. Date: Sep. 18, 2014

(54) Composite Sensor and Method for Manufacturing The Same

(71) Applicants: Takanori Aono, Tokyo (JP); Kengo Suzuki, Tokyo (JP); Masahide Hayashi, Hitachinaka (JP); Heewon Jeong, Tokyo (JP)

(72) Inventors: Takanori Aono, Tokyo (JP); Kengo Suzuki, Tokyo (JP); Masahide Hayashi, Hitachinaka (JP); Heewon Jeong, Tokyo (JP)

(73) Assignee: Hitachi Automotive Systems, Ltd., Ibaraki (JP)

(21) Appl. No.: 14/353,635

(22) PCT Filed: Nov. 28, 2011
(86) PCT No.: PCT/JP2011/006591

§ 371 Date: Apr. 23, 2014

(51) Int. Cl. G01C 19/5705

(52) U.S. Cl. CPC G01C 19/5705
USPC 73/504.12

(57) ABSTRACT

The disclosure provides a composite sensor with high reliability and a method for manufacturing the same. A moving body of an acceleration sensor and an oscillator of an angular velocity sensor are provided on the same sensor wafer, while being partitioned by a wall, and a cap wafer is formed to have a gap that corresponds to each of the sensors. A through hole and a bump are formed in a sensor sealing portion, the acceleration sensor is sealed in an air atmosphere in a first sealing process, and in a second sealing process, the angular velocity sensor is sealed by bringing the sensors and the cap into contact with each other and joining the sensors and the cap in a vacuum atmosphere. Thereafter, a composite sensor wafer is cut, a circuit board and a wiring board are mounted thereon, and a composite sensor is formed.

### TECHNICAL FIELD

The present invention relates to a physical quantity sensor that is used to measure a physical quantity, and a method for manufacturing the physical quantity detection sensor.

### BACKGROUND ART

In the related art, various capacitive physical quantity sensors are provided. The physical quantity sensor is manufactured by providing movable mechanism components such as an oscillator and a movable body on a silicon substrate or a glass substrate by using micro machining; by providing a driving gap at locations on a cap substrate, at which the driving gap corresponds to the movable mechanism components such as the oscillator or the movable body; and then by sealing the substrates by joining, bonding and the like. Since the sizes of the movable mechanism components are on the order of microns [μm], and characteristics thereof deteriorate due to an influence such as air resistance, and it is necessary to seal a sensing unit in a pressurized atmosphere that corresponds to each of the movable mechanism components such as the oscillator and the movable body.

Since an acceleration sensor, an angular velocity sensor, and the like are provided on the same substrate, the composite sensor is sealed in a pressurized atmosphere that prevents deterioration of the characteristics of each of the acceleration sensor and the angular velocity sensor. Typically, when a sensing unit of the acceleration sensor is sealed under an atmospheric pressure, and a sensing unit of the angular velocity sensor is sealed in a vacuum state, the composite sensor without deterioration of characteristics is obtained.

The angular velocity sensor has the oscillator as the movable mechanism component, and if an angular velocity is exerted on the angular velocity sensor when the oscillator is driven to oscillate at a constant frequency, a Coriolis force occurs. The oscillator is displaced by the Coriolis force. The angular velocity sensor detects an angular velocity by detecting the amount of displacement of the oscillator caused by the Coriolis force.

Since the Coriolis force becomes great to the extent that a drive velocity of the oscillator becomes high, it is necessary to oscillate the oscillator at a high frequency and great amplitude of several μm in order for the angular velocity sensor to have good detection sensitivity. However, since the oscillator manufactured by micro machining is formed at a tiny gap, when an atmosphere at the driving is at an atmospheric pressure, the oscillator is greatly affected by a damping effect of air (seal gas). The damping effect affects the oscillation of the angular velocity sensor at a high frequency and great amplitude and thus, the detection sensitivity of the angular velocity sensor decreases.

Accordingly, when the sensing unit of the angular velocity sensor is sealed in a state where the angular velocity sensor is less affected by the damping effect, that is, in a vacuum atmosphere, it is possible to obtain the angular velocity sensor that can oscillate at a high frequency and great amplitude.

In contrast, the movable mechanism component of the acceleration sensor is a moving body configured to have a pendulum, a beam, or the like. When acceleration is exerted on the acceleration sensor, the moving body is displaced. The acceleration sensor detects acceleration by detecting the amount of displacement of the moving body. When the acceleration sensor is sealed in the same vacuum state as that of the angular velocity sensor and thus, the damping effect is small, the moving body of the acceleration sensor happens to continuously oscillate and the acceleration sensor cannot detect acceleration with sensitivity.

Accordingly, the acceleration sensor is sealed in a state where the damping effect is great, that is, in an air atmosphere.

For example, technologies disclosed in PTL 1 to PTL 3 are widely known examples of the composite sensor into which the acceleration sensor and the angular velocity sensor are combined.

In PTL 1, a through hole (air passage) is provided on a side of the acceleration sensor in the cap substrate that seals the acceleration sensor and the angular velocity sensor. After the acceleration sensor and the angular velocity sensor are sealed in a vacuum state, the acceleration sensor and the angular velocity sensor are sealed with a damping agent via the air passage, the through hole is plugged with a solder, a resin, or the like, the acceleration sensor is sealed in an air atmosphere, and the angular velocity sensor is sealed in a vacuum atmosphere.

In PTL 2, after the acceleration sensor and the angular velocity sensor are sealed in an air atmosphere, a through hole is formed in the cap substrate or the sensor substrate of the angular velocity sensor. Thereafter, the angular velocity sensor is sealed under a pressure when a chemical vapor deposition (CVD) method is carried out, that is, in a vacuum atmosphere by plugging the through hole with silicon or the like by using the CVD method. The method is configured to seal the acceleration sensor and the angular velocity sensor, respectively, in an air atmosphere and in the vacuum atmosphere.

PTL 3 discloses a method in which in order for a device to be sealed under a specific pressure, an air passage in a device is formed to connect the device to an outer circumference of a wafer, and a pressure inside the device is adjusted via the air passage.

### CITATION LIST

### Patent Literature

PTL 1: JP-A-2002-5950
PTL 2: JP-T-2008-501535
PTL 3: JP-A-2010-251568

### SUMMARY OF INVENTION

### Technical Problem

However, it is necessary to seal the acceleration sensor and the angular velocity sensor provided on the same substrate under pressures that respectively correspond thereto in order to improve detection sensitivity thereof. Since both sensors are sealed on the same substrate, it is easy to carry out sealing in a pressured atmosphere that corresponds to a sensing unit of any one of the acceleration sensor and the angular velocity sensor, in a state where a pressure adjustment is carried out via the air passage connected to the outer circumference of the wafer as described in PTL 3. However, in order to carry out sealing in a pressured atmosphere that correspond to both of the sensing units, as described in PTL 1 and PTL 2, there is a method in which an air passage such as a through hole is formed in the cap substrate, the gap substrate is joined to the sensor substrate, and the through hole is plugged with a separate material.

However, in the method in PTL 3, it is possible to deal with the sealing of a sensor under a single pressure, but it is not possible to deal with a device such as a composite sensor that has different drive environment. A pressure distribution in the device becomes large due to difference in flow passage resistance of the air passage connected to the outer circumference of the wafer.

In contrast, the methods in PTL 1 and PTL 2 have the following problems: (1) a decrease in reliability caused by expansion and contraction resulting from difference in coefficients of linear expansion of silicon or glass and a material with which the through hole is plugged, and caused by deterioration of adhesion therebetween; (2) high costs due to a complicated manufacturing process.

An object of the present invention is provide a composite sensor with improved reliability and a method for manufacturing the same.

### Solution to Problem

A composite sensor wafer of the present invention is configured to have an acceleration sensor and an angular velocity sensor disposed close to each other, and have a plurality of sensor wafers provided on the same substrate, and cap wafers that seal the sensors.

A composite sensor is manufactured by (1) a process of forming the composite sensor wafer by joining the sensor wafer and the cap wafer and sealing a sensing unit; (2) a process of forming a composite sensor chip by dicing the composite sensor wafer; (3) a process of mounting the composite sensor chip, a wiring board that has an external input and output terminal, and a circuit board that compensates for a detection on each other; (4) a process of connecting electrodes of the composite sensor chip, the wiring board, and the circuit board to each other via wires; and (5) a process of sealing the composite sensor chip, the circuit board and the wiring board with a resin package, a ceramic package or the like.

### Advantageous Effects of Invention

According to the present invention, it is possible to provide a composite sensor with high reliability and a method for manufacturing the same.

### BRIEF DESCRIPTION OF DRAWINGS

FIG. 1 is a schematic view of a joint of a composite sensor wafer according to an embodiment of the present invention.

FIG. 2 is an enlarged view of a composite sensor chip according to first to third embodiments of the present invention.

FIG. 3 is an enlarged view of through holes and bumps according to the first to the third embodiments of the present invention.

FIG. 4 is a cross-sectional view of an angular velocity sensor according to the first embodiment of the present invention.

FIG. 5 is a cross-sectional view of an acceleration sensor according to the first embodiment of the present invention.

FIG. 6 is a cross-sectional view of an angular velocity sensor according to the second embodiment of the present invention.

FIG. 7 is a cross-sectional view of an acceleration sensor according to the second embodiment of the present invention.

FIG. 8 is a cross-sectional view of an angular velocity sensor according to the third embodiment of the present invention.

FIG. 9 is amounting configuration of a composite sensor according to a fifth embodiment of the present invention.

FIG. 10 is a mounting configuration of a composite sensor according to a sixth embodiment of the present invention.

### DESCRIPTION OF EMBODIMENTS

Hereinafter, embodiments according to the present invention will be described with reference to the accompanying drawings.

### Example 1

As illustrated in FIG. 1, a sensor chip 10 is configured to have an acceleration sensor 11 and an angular velocity sensor 12, and a cap chip 20 is configured to have an acceleration sensor gap 21 and an angular velocity sensor gap 22. A composite sensor wafer 3 is formed by joining and sealing a sensor wafer 1 on which a plurality of the sensor chips 10 are disposed, and a cap wafer 2 on which a plurality of the cap chips 20 are disposed.

FIG. 2 is a first embodiment of the present invention, and an enlarged view of parts of the sensor wafer 1 and the cap wafer 2 in FIG. 1.

The sensor chip 10 is configured to form the acceleration sensor 11, the angular velocity sensor 12, a through hole 13 connected to a back surface of the wafer, and a connection portion 14 connected to the cap chip 20 on a silicon on insulator (SOI) substrate. The SOI substrate is a substrate that is configured to have a silicon oxide layer formed between silicon and silicon. A moving body 111 and a detection element 112 of the acceleration sensor 11, and an oscillator 121 and a detection element 122 of the angular velocity sensor 12 are formed on a side of an active layer of the SOI substrate by using Si deep reactive ion etching (DRIE). Thereafter, the moving body 111, the oscillator 121, and the detection elements 112 and 122 are released by removing the silicon oxide layer. The moving body 111 and the detection element 112, and the oscillator 121 and the detection element 122 are disposed, while being partitioned by a wall 16.

The detection element 112 of the acceleration sensor 11, and the oscillator 121 and the detection element 122 of the angular velocity sensor are connected to an electrode pad 17 on the back surface of the SOI substrate via a through-hole electrode, and are configured to detect a drive and the amount of displacement by an input and output of a signal from the electrode pad 17.

The through hole 13 is formed in the thickness direction of the wafer by carrying out dry etching of silicon on the active layer and a handle layer, an insulation film such as a silicon oxide film is formed on a side wall of the through hole 13, the through hole 13 is plugged with polysilicon or the like, and then an electrode is formed on a side of the handle layer. When the through hole 13 on the side of the handle layer is formed to have a size larger than that of the through hole 13 on the side of the active layer, and the through hole on the side of the handle layer is plugged with polysilicon. Since the through hole 13 on the side of the handle layer is larger than the through hole 13 on the side of the active layer, the through hole 13 on the side of the handle layer is not fully plugged. Accordingly, when the polysilicon is removed from the through hole 13 on the side of the active layer, the through holes 13 on the sides of the active layer and the handle layer are opened, and it is possible to form a through hole in the thickness direction of the wafer. In this way, the through hole 13 is configured to be provided in the connection portion 14.

In a specific method for forming the through holes 13, the through hole 13 with a diameter of 20 μm or larger is formed on the side of the handle layer, and the through hole 13 with a diameter of approximately 10 μm is formed on the side of the active layer. After an insulation film such as an oxide film is formed on the side wall of the through hole 13, the through hole 13 is plugged by laminating polysilicon in a thickness of 5 μm or larger using a CDV method. At this time, polysilicon is laminated even on the side wall of the through hole on the side of the handle layer, but the through hole is not fully plugged. Thereafter, when the oscillator 121 and the detection element 122 of the angular velocity sensor 12 are manufactured, the through hole 13 plugged with polysilicon is penetrated through by using dry etching and thus, the through hole 13 is formed in the thickness direction of the wafer.

In the embodiment, the through hole 13 is provided in the connection portion 14 on a side of the angular velocity sensor 12, but the through hole 13 may be provided in the connection portion 14 on a side of the acceleration sensor 11.

A structure of the vicinity of the through hole 13 according to the first embodiment will be described with reference to FIG. 3(a). The embodiment has a configuration in which the through hole 13 is formed in the sensor chip 10, and a plurality of bumps 23 are formed in the cap chip 20 to surround the through hole 13. The bump is formed to have a diameter of 10 μm or larger and a height of 0.5 μm or larger.

Subsequently, a joint and sealing of the sensor wafer 1 and the cap wafer 2 according to the first embodiment will be described with reference to FIGS. 4 and 5. FIG. 4 is a cross-sectional view of the angular velocity sensor taken along A-A′ in FIG. 2. FIG. 5 is a cross-sectional view of the acceleration sensor taken along B-B′ in FIG. 2. The cap wafer 2 is made of glass, and is configured to have an acceleration sensor gap 21, an angular velocity sensor gap 22, and the bumps 23 provided on the connection portion 14 of the angular velocity sensor. An adsorbent 24 is formed in the angular velocity sensor gap 22. When the adsorbent 24 for pressure adjustment is disposed in the angular velocity sensor gap 22, even though active gas adsorbed on the surfaces of the cap chip 20 and the sensor chip 10 is desorbed therefrom, the desorbed active gas is adsorbed by the adsorbent 24 and thus, the active gas is not affecting drive environment of the angular velocity sensor, and it is possible to improve pressure reliability in the angular velocity sensor.

The bump 23 formed on the cap chip 20 is formed to have a diameter of 10 μm or larger and a height of 0.5 μm or larger by carrying out isotropic etching with buffered hydrofluoric acid. The bump 23 may be formed by patterning a metallic film with a milling, a lift-off, an etching or the like. When a metallic film is used, the bump 23 may be provided in the vicinity of the through hole formed on a joint side (side of the active layer) of the SOI substrate.

The acceleration sensor gap 21 and the angular velocity sensor gap 22 are formed by carrying out isotropic etching with hydrofluoric acid. The acceleration sensor gap 21 and the angular velocity sensor gap 22 may be formed by using dry etching other than isotropic etching. Thereafter, the adsorbent 24 (getter) is deposited on the angular velocity sensor gap 22.

In a first stage of the sealing process, after the sensor wafer 1 and the cap wafer 2 are aligned (FIGS. 4(a) and 5(a)), a pressure is adjusted to an air atmosphere with argon gas, the sensor wafer 1 and the cap wafer 2 are anode joined at a joint temperature of 250° C., while a voltage being applied to therebetween (FIGS. 4(b) and 5(b)). At this time, the acceleration sensor 11 is joined and sealed in an air atmosphere, but the bump 23 hinders the joint of the angular velocity sensor 12, and a gap 15 is formed. It is possible to adjust an internal pressure of the angular velocity sensor via an air passage formed by the bump 23 and the through hole 13. At this time, when an air passage connected to an outer circumference of the wafer is used, a sealed pressure is distributed between a center portion and an outer circumferential portion of the wafer due to difference in flow passage resistance of the air passage. When a through hole for each of the sensors is provided and thus, a pressure adjustment is carried out via each through hole, it is possible to decrease flow passage resistance to the extent that the wafer has a small thickness (several tens of μm to several hundreds of μm), it is possible to set the flow passage resistance to 10⁻⁴ or less compared to when a pressure adjustment is carried out via the air passage (several cm to several tens of cm) that is connected to the outer circumference of the wafer as illustrated in PTL 3, and it is possible to greatly reduce a pressure distribution on the surface of the wafer since it is possible to reduce a distribution of the flow passage resistance on the surface of the wafer. Since a joint area becomes small, it is possible to reduce a degassing operation at the time of joining, and to reduce a pressure distribution on the surface of the wafer.

Subsequently, a pressure in the angular velocity sensor 12 is adjusted to a vacuum atmosphere via the through hole 13 and the gap 15. In this state, in a second stage sealing process, the sensor wafer 1 and the cap wafer 2 are anode joined at a joint temperature of 500° C. or higher, while a voltage being applied to therebetween in a state in which a load is applied to the cap wafer 2 (FIGS. 4(C) and 5(C)). At this time, the bump 23 is subject to plastic deformation, the gap 15 surrounding the through hole 13 of the angular velocity sensor 12 is crushed, a joint progresses, and it is possible to seal the angular velocity sensor 12 in a vacuum atmosphere. In the aforementioned method, the composite sensor wafer 3 is formed by sealing the acceleration sensor 11 in an air atmosphere, and the angular velocity sensor 12 in a vacuum atmosphere.

When the cap wafer 2 is made of glass, after positions of the sensor wafer 1 and the cap wafer 2 are aligned, in a first stage of the sealing process, a pressure is adjusted to the atmospheric pressure with noble gas such as argon gas or inert gas, and the acceleration sensor is sealed at a temperature of 200° C. to 400° C., while a voltage is applied to the sensor wafer 1 and the cap wafer 2. At this time, the bump 23 hinders the joint, and the angular velocity sensor is not sealed. Subsequently, in a second stage of the sealing process, a pressure is adjusted to a drive pressure (vacuum atmosphere) of the angular velocity sensor with noble gas such as argon gas or inert gas, and the angular velocity sensor is sealed at a temperature of 500° C. or higher, while a load is applied and a voltage is applied to the sensor wafer 1 and the cap wafer 2. Since the load is applied at a high temperature atmosphere, the bump 23 deforms, the wafers come into contact with each other and are joined, and the angular velocity sensor is sealed in a vacuum atmosphere.

In the embodiment, in the first stage and the second stage of the sealing process, it is possible to form a composite sensor that conforms to drive environment of a first sensor and a second sensor by changing a pressure in a chamber.

A material, which is easily subject to plastic deformation by a temperature, a load or the like, is used in the bump 23, and a plurality of the bumps 23 are disposed in the vicinity of the through hole of the sensor wafer. The method is different from the method for sealing the through hole with a separate material as described in PTL 1 and PTL 2, and it is possible to carry out sealing in a series of joint processes, and it is possible to achieve high reliability sealing and manufacturing cost reduction.

When the through hole 13 is formed in the acceleration sensor 11, in the first stage sealing process, the acceleration sensor 11 is sealed in a vacuum atmosphere that is a drive pressure of the angular velocity sensor 12. At this time, the bump 23 hinders the sealing of the acceleration sensor 11 and thus, the acceleration sensor 11 is not sealed. In this state, when a pressure in the chamber is adjusted to an air atmosphere that is a drive pressure of the acceleration sensor 11, it is possible to set a pressure in the acceleration sensor to a vacuum atmosphere by using a gap formed by the through hole 13 and the bump 23. Thereafter, in the second stage sealing process, when at a high temperature and a high load, the bump 23 deforms and a peripheral portion of the through hole is sealed, it is possible to seal the acceleration sensor in an air atmosphere, and similarly to a case where the through hole 13 is formed in the angular velocity sensor 12, it is possible to carry out sealing in a series of joint processes, and it is possible to achieve high reliability sealing and manufacturing cost reduction.

### Example 2

A joint and sealing of the sensor wafer 1 and the cap wafer 2 according to a second embodiment will be described with reference to FIGS. 6 and 7. FIG. 6 is a cross-sectional view of the angular velocity sensor taken along A-A′ in FIG. 2. FIG. 7 is a cross-sectional view of the acceleration sensor taken along B-B′ in FIG. 2. The cap wafer 2 is made of silicon, and the acceleration sensor gap 21 and the angular velocity sensor gap 22 are formed by carrying out anisotropic etching with an aqueous potassium hydroxide solution. Alternatively, the gaps may be formed by carrying out isotropic etching, dry etching or the like with a mixed liquid of hydrofluoric acid, nitric acid and acetic acid.

Subsequently, a Cr film (0.05 μm) and an Au film (0.5 μm) are sequentially deposited on the side of the angular velocity sensor gap 22 by carrying out sputtering with metal mask. Similarly to in the Example 1, the adsorbent 24 (getter) is deposited on the angular velocity sensor gap 22.

In a first stage sealing process, after the sensor wafer 1 and the cap wafer 2 are aligned (FIGS. 6(a) and 7(a)), the surfaces of the sensor wafer 1 and the cap wafer 2 are activated with argon plasma, a pressure is adjusted to an air atmosphere with argon gas, and the sensor wafer 1 and the cap wafer 2 are joined by surface activation, while coming into contact with each other (FIGS. 6(b) and 7(b)). At this time, the acceleration sensor 11 is joined and sealed in an air atmosphere, but the bumper 23 hinders the joint of the angular velocity sensor 12 and the gap 15 is formed.

Subsequently, a pressure in the angular velocity sensor 12 is adjusted to a vacuum atmosphere via the through hole 13 connected to the back surface of the wafer and the gap 15. Specifically, after the surface is activated, a pressure is adjusted to a drive pressure (vacuum atmosphere) of the angular velocity sensor with noble gas such as argon gas or inert gas. In this state, in a second stage sealing process, the surface is anew activated with argon plasma, and in a state where a load is exerted on the sensor wafer 1 and the cap wafer 2, the sensor wafer 1 and the cap wafer 2 are joined by surface activation, while coming into contact with each other (FIGS. 6(C) and 7(C)). At this time, the bump 23 is subject to plastic deformation, the gap 15 in a portion of the through hole 13 is crushed, a joint progresses, and it is possible to seal the angular velocity sensor 12 in a vacuum atmosphere. In the aforementioned method, the composite sensor wafer is formed by sealing the acceleration sensor 11 in an air atmosphere, and the angular velocity sensor 12 in a vacuum atmosphere.

When a metal bump is used as the bump 23, in the second stage sealing process, in a state where a load is exerted to deform the metal bump, the angular velocity sensor may be sealed at a temperature of 200° C. to 400° C., while a voltage is applied to the sensor wafer 1 and the cap wafer 2. In the light of the plastic deformation of the bump 23, a groove may be formed in the sensor wafer 1 or the cap wafer 2, and the groove is formed to be wider than the diameter of the bump 23 and shallower than the height of the bump 23 to conform to the deformation of the bump 23.

### Example 3

A joint and sealing of the sensor wafer 1 and the cap wafer 2 according to a third embodiment will be described with reference to FIG. 8. FIG. 8 is a cross-sectional view of the angular velocity sensor taken along A-A′ in FIG. 2. The acceleration sensor is the same as that of the second embodiment. The cap wafer 2 is made of silicon, and the acceleration sensor gap 21 and the angular velocity sensor gap 22 are formed by carrying out anisotropic etching with an aqueous tetramethylammonium solution. Subsequently, after a Cr film (0.05 μm) and an In film (0.5 μm) are sequentially deposited on the connection portion 14 of the angular velocity sensor 12 by carrying out sputtering with metal mask, the connection portion 14 is subject to photolithography and dry etching of silicon starting from the back surface and thus, the through hole 13 is formed. Similarly to in the Example 1, the adsorbent 24 (getter) is deposited on the angular velocity sensor gap 22.

A structure of the vicinity of the through hole 13 according to the third embodiment will be described with reference to FIG. 3(b). The embodiment has a configuration in which the through hole 13 is formed in the cap chip 20 by using Si DRIE, and the plurality of bumps 23 are formed to surround the through hole 13. The bump is formed to have a diameter of 10 μm or larger and a height of 0.5 μm or larger.

After the sensor wafer 1 and the cap wafer 2 are aligned (FIG. 8(a)), the surfaces of the sensor wafer 1 and the cap wafer 2 are activated with argon plasma, a pressure is adjusted to an air atmosphere with argon gas, and the sensor wafer 1 and the cap wafer 2 are joined by surface activation, while coming into contact with each other (FIG. 8(b)). At this time, the acceleration sensor 11 is joined and sealed in an air atmosphere, but the bump 23 hinders the joint of the angular velocity sensor 12 and the gap 15 is formed. Subsequently, when a pressure is set to a vacuum atmosphere, a pressure in the angular velocity sensor 12 is adjusted to a vacuum atmosphere via the through hole 13 connected to the back surface of the cap wafer and the gap 15. Herein, the surface is anew activated with argon plasma, and in a state where a load is exerted on the sensor wafer 1 and the cap wafer 2, the sensor wafer 1 and the cap wafer 2 are joined by surface activation, while coming into contact with each other (FIG. 8 (c)). At this time, the bump 23 is subject to plastic deformation, the gap 15 of the through hole 13 is crushed, a joint progresses, and it is possible to seal the angular velocity sensor 12 in a vacuum atmosphere. In the aforementioned method, the composite sensor wafer is formed by sealing the acceleration sensor 11 in an air atmosphere, and the angular velocity sensor 12 in a vacuum atmosphere.

### Example 4

FIG. 9 illustrates a fourth embodiment of the present invention, and is a cross-sectional view describing a process of cutting and mounting the composite sensor wafer 3 of Examples 1 to 3, and forming a composite sensor. FIG. 9(a) is a cross-sectional view of the composite sensor wafer 3 taken along C-C′ in FIG. 2. FIG. 9(b) illustrates a process of cutting and dicing the composite sensor wafer 3 by CO₂ laser into composite sensor chips 30.

By using a die attach film, an Ag paste or the like, a circuit board 40 is disposed on a wiring board 50 such as a lead frame on which an external input and output electrode 51 made of a metal is formed (FIG. 9(c)). The circuit board 40 is mounted with a circuit that detects a displacement of the composite sensor chip 30, and circuits that compensate for a temperature, a slope and the like. Subsequently, the composite sensor chip 30 is disposed on the circuit board 40 by using a die attach film, a Si adhesive or the like (FIG. 9(d). Subsequently, as illustrated in FIG. 9(e)), the electrode pad 17 of the composite sensor chip 30, an electrode 41 of the circuit board 40, and the external input and output electrode 51 of the wiring board 50 are connected to each other via a wire 60. Finally, the composite sensor chip 30, the circuit board 40, the wiring board 50 and the wire 60 made of Au or the like are sealed with resin by using injection molding, potting or the like (FIG. 9(f)). An epoxy based resin, with which particles such as silica are mixed, is used as the resin material.

In the aforementioned configuration, it is possible to seal the acceleration sensor and the angular velocity sensor on the same substrate in a drive atmosphere for each sensor. It is possible to provide a composite sensor with low manufacturing costs and a method for manufacturing the same.

### Example 5

FIG. 10 illustrates a fifth embodiment of the present invention, and is a cross-sectional view describing a process of cutting and mounting the composite sensor wafer 3 of Examples 1 to 4, and forming a composite sensor. FIG. 10(a) is a cross-sectional view of the composite sensor wafer 3 taken along C-C′ in FIG. 2. FIG. 10(b) illustrates a process of cutting and dicing the composite sensor wafer 3 by a diamond grind stone into the composite sensor chips 30.

By using a die attach film, an Ag paste or the like, the circuit board 40 is disposed on a package 80 on which the external input and output electrode 51 is connected to a ceramic or plastic multi-layer wiring (FIG. 10(c)). The circuit board 40 is mounted with a circuit that detects a displacement of the composite sensor chip 30, and circuits that compensate for a temperature, a slope and the like. As illustrated in FIG. 10(d), the composite sensor chip 30 is disposed on the circuit board 40 by using a die attach film, a Si adhesive or the like. Subsequently, as illustrated in FIG. 10(e), the electrode pad 17 of the composite sensor chip 30, the electrode 41 of the circuit board 40, and an electrode 81 of the ceramic package 80 are connected to each other via the wire 60 made of Au or the like. Finally, a lid 82 is joined to an opening portion of the ceramic package 80 in inert gas by soldering (FIG. 10(f)).

Similarly to in the fourth Example, in the aforementioned configuration, it is possible to seal the acceleration sensor and the angular velocity sensor on the same substrate in a drive atmosphere for each sensor. It is possible to provide a composite sensor with low manufacturing costs and a method for manufacturing the same.

### REFERENCE SIGNS LIST

1 sensor wafer
2 cap wafer
3 composite sensor wafer
10 sensor chip
11 acceleration sensor
12 angular velocity sensor
13 through hole
14 joint portion
17 electrode pad
15 gap
16 wall
20 cap chip
21 acceleration sensor gap
22 angular velocity sensor gap
23 bump
24 adsorbent (getter)
30 composite sensor chip
40 circuit board
41, 81 electrode
50 wiring board
51 external input and output electrode
60 wire
70 resin
80 ceramic package
82 lid
111 moving body
112, 122 detection element
121 oscillator

1. A composite sensor that is configured to have a sensor wafer which has an angular velocity detection unit that detects an angular velocity by using an oscillator, and an acceleration detection unit that detects acceleration by using a moving body, which are respectively provided in spaces partitioned by a wall, and which has a through hole formed in either an area of the angular velocity detection unit or a joint portion; and a cap wafer in which a gap is formed at each of locations that correspond to the sensors, and a bump is formed in the vicinity of the through hole formed in the angular velocity detection unit,
wherein the sensor is manufactured by:
a process of sealing the acceleration detection unit in an air atmosphere, which is a first sealing process;
a process of sealing the angular velocity detection unit at a high temperature and a high load in a vacuum atmosphere, which is a second sealing process; a process of dicing a composite sensor wafer into a composite sensor chip by a cutting;
a process of providing a circuit board that compensates for a detection on a wiring board that has an external input and output terminal;
a process of providing the composite sensor chip on the circuit board;
a process of connecting the composite sensor chip, the circuit board, and the wiring board to each other via a wire; and
a process of sealing the composite sensor chip and the circuit board except for a part of the wiring board with a resin.

2. A composite sensor that is configured to have a sensor wafer which has an angular velocity detection unit that detects an angular velocity by using an oscillator, and an acceleration detection unit that detects acceleration by using a moving body which are provided, respectively, in spaces partitioned by a wall, and which has a through hole formed in either an area of the acceleration detection unit or a joint portion; and a cap wafer in which a gap is formed at each of locations that correspond to the sensors, and a bump is formed in the vicinity of the through hole formed in the acceleration detection unit,
wherein the sensor is manufactured by:
a process of sealing the angular velocity detection unit in a low vacuum atmosphere, which is a first sealing process;
a process of sealing the acceleration detection unit at a high temperature and a high load in an air atmosphere, which is a second sealing process;
a process of dicing a composite sensor wafer into a composite sensor chip by a cutting;
a process of providing a circuit board that compensates for a detection on a wiring board that has an external input and output terminal;
a process of providing the composite sensor chip on the circuit board;
a process of connecting the composite sensor chip, the circuit board, and the wiring board to each other via a wire; and
a process of sealing the composite sensor chip and the circuit board except for a part of the wiring board with a resin.

3. The composite sensor according to claim 1,
wherein the sensor wafer is made of a silicon substrate or a substrate configured to have a silicon oxide layer formed between silicon and silicon, and
wherein the cap wafer is made of a glass substrate or a silicon substrate.

4. The composite sensor according to claim 1,
wherein the bump has a diameter of 10 μm or larger and a height of 0.5 μm or larger.

5. The composite sensor according to claim 4,
wherein the bump is made of glass or a metal.

6. The composite sensor according to claim 1,
wherein a first-axis angular velocity detection unit and a second-axis acceleration detection unit are provided on the same plane, and detection axes of the angular velocity detection unit and the acceleration detection unit are orthogonal to each other.

7. The composite sensor according to claim 2,
wherein the sensor wafer is made of a silicon substrate or a substrate configured to have a silicon oxide layer formed between silicon and silicon, and
wherein the cap wafer is made of a glass substrate or a silicon substrate.

8. The composite sensor according to claim 2,
wherein the bump has a diameter of 10 μm or larger and a height of 0.5 μm or larger.

9. The composite sensor according to claim 2,
wherein a first-axis angular velocity detection unit and a second-axis acceleration detection unit are provided on the same plane, and detection axes of the angular velocity detection unit and the acceleration detection unit are orthogonal to each other.
